(19) United States
(12) Patent Application Publication
(10) Pub. No.: US 2017/0045182 A1
(43) Pub. Date: Feb. 16, 2017

(54) Enhanced Storage System

(71) Applicant: J-W Power Company, Addison, TX (US)

(72) Inventors: Richard Allan Poorman, Diana, TX (US); Heidi Sue Tryon, Kilgore, TX (US)

(21) Appl. No.: 15/236,397

(22) Filed: Aug. 13, 2016

Related U.S. Application Data
(60) Provisional application No. 62/204,535, filed on Aug. 13, 2015.

(51) Int. Cl. F17C 5/06

(52) U.S. Cl. CPC F17C 5/06; F17C 2221/033; F17C 2223/0123; F17C 2225/0123; F17C 2250/0626; F17C 2260/021; F17C 2265/065

(57) ABSTRACT

A compressed natural gas (CNG) refueling station system includes a station storage container configured to receive gas at a first pressure, a dispenser configured to deliver CNG to a vehicle tank up to a second pressure below the first pressure, and a pressure regulator disposed between the station storage container and the dispenser.

### CROSS-REFERENCE TO RELATED APPLICATIONS

This patent application claims the benefit of the filing date of the U.S. Provisional Patent Application Ser. No. 62/204,535, filed on Aug. 13, 2015 and entitled “Enhanced Storage System,” the entire content of which is hereby expressly incorporated by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Dispensing compressed natural gas (CNG) can sometimes be limited by a pressure rating of a vehicle tank.

### BRIEF DESCRIPTION OF THE DRAWINGS

FIG. 1 is a schematic diagram of a compressed natural gas (CNG) storage system according to a first prior art system.

FIG. 2 is a schematic diagram of a compressed natural gas (CNG) storage system according to a second prior art system.

FIGS. 3 and 4 are graphs showing relationships between storage capacity and pressure.

FIG. 5 is schematic diagram of an enhanced storage system according to an embodiment of this disclosure

FIG. 6 is schematic diagram of an enhanced storage system according to another embodiment of this disclosure.

FIG. 7 is schematic diagram of an enhanced storage system according to another embodiment of this disclosure,

FIG. 8 is schematic diagram of an enhanced storage system according to another embodiment of this disclosure.

FIG. 9 is schematic diagram of an enhanced storage system according to another embodiment of this disclosure.

FIG. 10 is schematic diagram of an enhanced storage system according to another embodiment of this disclosure.

### DETAILED DESCRIPTION

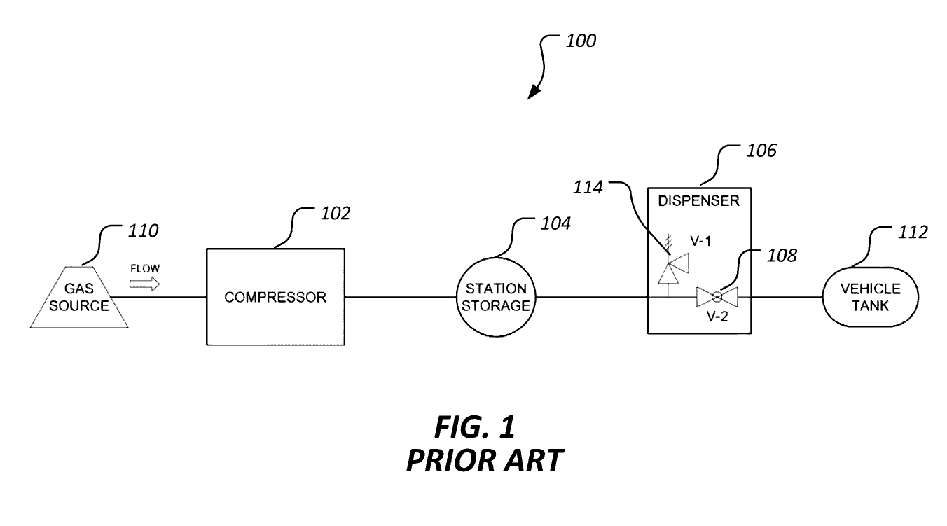

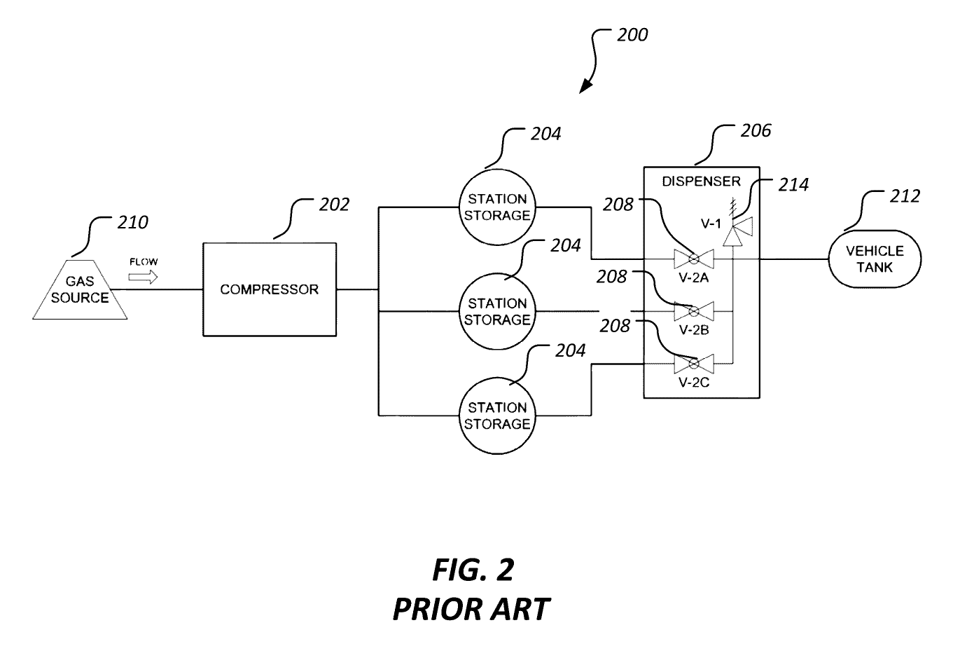

Referring to FIGS. 1 and 2, some compressed natural gas (CNG) refueling stations, systems 100 and 200, respectively, comprise some type and number of compressors 102, 202. System 100 generally comprises a single station storage container 104 and a single dispenser 106 comprising a dispenser valve 108. System 200 generally comprises multiple station storage containers 204 and a dispenser 206 comprising dispenser valves 208. The CNG refueling stations 100, 200 take gas from a source 110, 210 and compress it to a selected pressure. The pressurized gas is stored in some arrangement of storage containers 102, 202. These storage containers 102, 202 are sometimes configured to feed the compressed and pressurized gas through a dispenser 106, 206 and then to pass the gas into a vehicle tank 112, 212. The systems 100, 200 are designed to deliver gas to the vehicle tank 112, 212 and ensure that the vehicle tank 112, 212 is filled to the maximum allowable pressure without exceeding the maximum allowable pressure of the vehicle tank 112, 212. This ensures that the vehicle tank 112, 212 can store the most fuel possible without exceeding the working limits of the vehicle tanks 112, 212 times mandated that the dispensers 106, 206 be provided overpressure protection through the use of a relief valve 114, 214 to provide a mechanical safe guard to prevent the vehicle tank pressure from rising above the safe working limits while it is filling. Since the station storage containers 102, 202 are connected to the dispenser 106, 206 during filling, the relief valve 114, 214 in the dispenser can sometimes serve as the limiting factor on how much pressure can be stored in the station storage containers 102, 202.

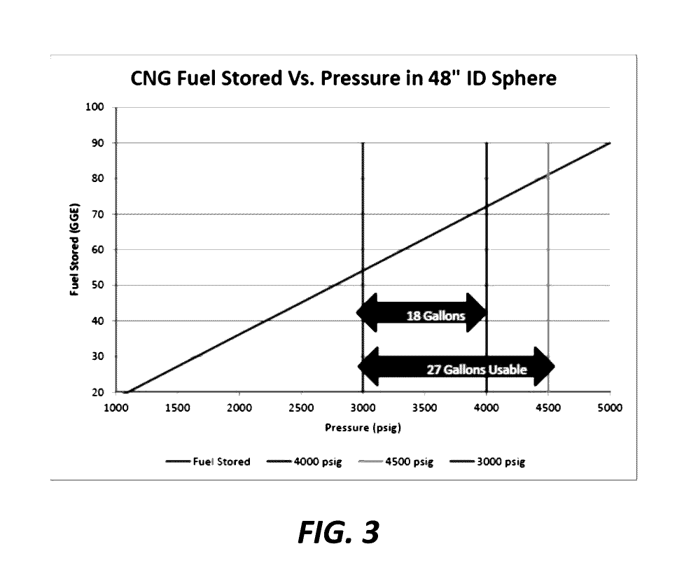

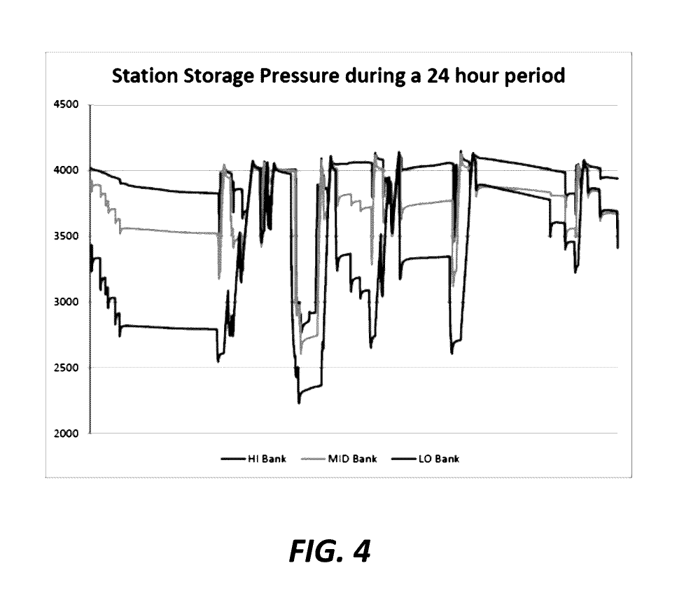

During the fill cycle (the filling of the vehicle tank 112, 212 from the station storage container(s) 104, 204), the gas flows from the station storage containers 104, 204 to the vehicle tank 112, 212 because .f a pressure differential, When the station storage containers 104, 204 and the vehicle tank 112, 212 are connected they are equalizing in pressure. The equalization phenomena prevents all of the gas in the station storage containers 104, 204 from being usable. Typically, only about a one-third of the gas originally held in the station storage container 104, 204 is usable to fill the vehicle tank 112, 212. Referring now to the graphs of FIGS. 3 and 4, when the pressure in the station storage containers 104, 204 are raised to a higher pressure, more of the gas stored in the station storage containers 104, 204 can flow into the vehicle tank 112, 212 before equalization occurs. Therefore, more of the gas originally held in station storage containers 104, 204 would be usable. However, the higher pressure of the station storage containers 104, 204 can cause the relief valves 114, 214 in the dispensers 106, 206 of systems 100 and 200 to open, releasing gas into the atmosphere.

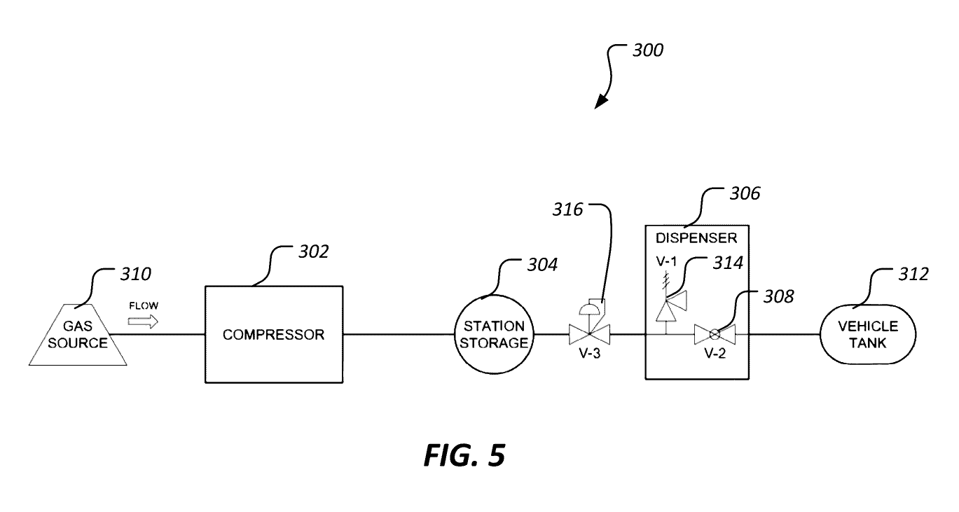

Referring now to FIG. 5, a CNG refueling station system 300 according to an embodiment of this disclosure is provided. The CNG refueling station system 300 comprises a compressor 302, a station storage container 304, a dispenser 306, a dispenser valve 308, a gas source 310, a vehicle tank 312, and a relief valve 314. The system 300 further comprises a pressure regulator 316 disposed between the station storage container 304 and the dispenser 306. The pressure regulator 316 is configured to limit the pressure coming out of the station storage container 304 and reduce the output pressure to a level that is safely below a preset pressure value of relief valve 314. Providing the pressure regulator 316 as described above can allow the pressure at which the gas is stored in the station storage containers 304 to be raised, increasing the usable amount of gas stored in the station storage containers 304. This can increase the flow rates of the gas, decreasing the amount of time required to fill the vehicle tank 312, lengthen the amount of time between running the compressor 302, and lengthen the time that the compressors 302 do run once they begin working.

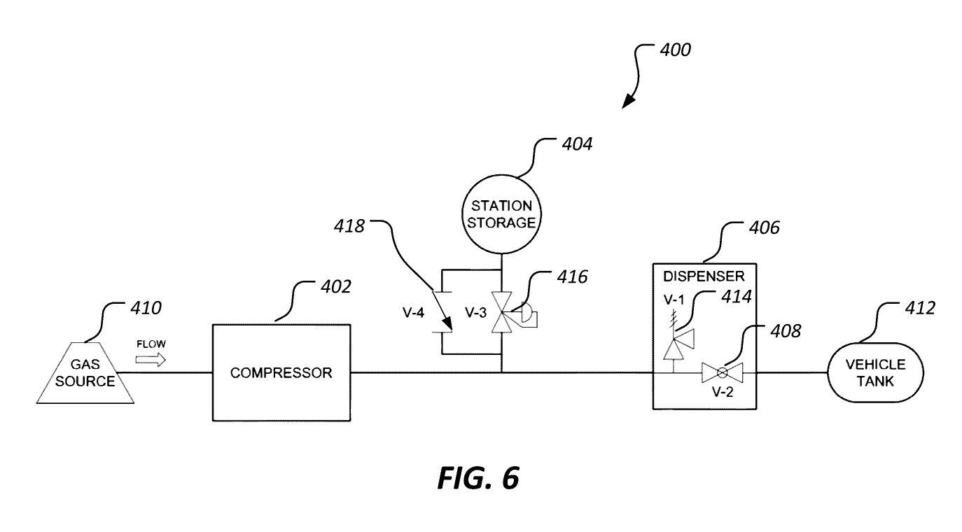

Referring now to FIG. 6, a CNG refueling station system 400 according to an embodiment of this disclosure is provided. The CNG refueling station system 400 comprises a compressor 402, a station storage container 404, a dispenser 406, a dispenser valve 408, a gas source 410, a vehicle tank 412, a relief valve 414, and a pressure regulator 416 disposed between the station storage container 404 and the dispenser 406. The system 400 is substantially similar to system 300 but further comprises a check valve 418 disposed in parallel with the pressure regulator 416. The addition of the check valve 418 can allow the line or fluid conduit that is in fluid communication with the station storage container 404 to be used for both introducing gas into the station storage container and removing gas from the station storage container.

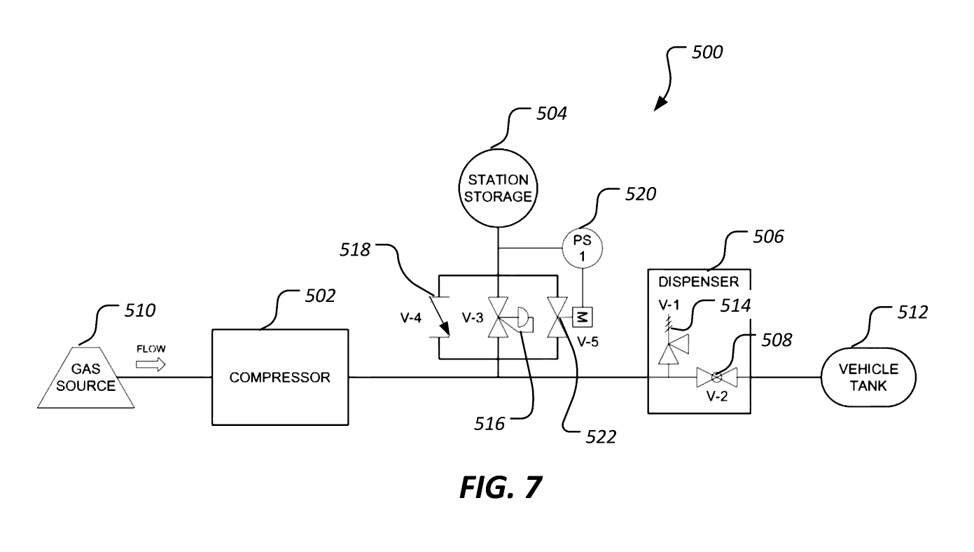

Referring now to FIG. 7, a CNG refueling station system 500 according to an embodiment of this disclosure is provided. The CNG refueling station system 500 comprises a compressor 502, a station storage container 504, a dispenser 506, a dispenser valve 508, a gas source 510, a vehicle tank 512, a relief valve 514, a pressure regulator 516 disposed between the station storage container 504 and the dispenser 506, and a check valve 518 disposed in parallel with the pressure regulator 516. The system 500 is substantially similar to the system 400 but further comprises a pressure switch 520 and actuated valve 522 disposed in parallel with the pressure regulator 516. in this embodiment, as the pressure in the station storage container 504 is reduced, the velocity of the gas through the pressure regulator 516 increases, causing the flow rate to go down. Once the pressure in the station storage container 504 is safely below a set point of the relief valve 514 at the dispenser 506, the pressure switch 520 will actuate the valve 522, opening the valve 522 and allowing the gas to flow without restriction to the dispenser 506.

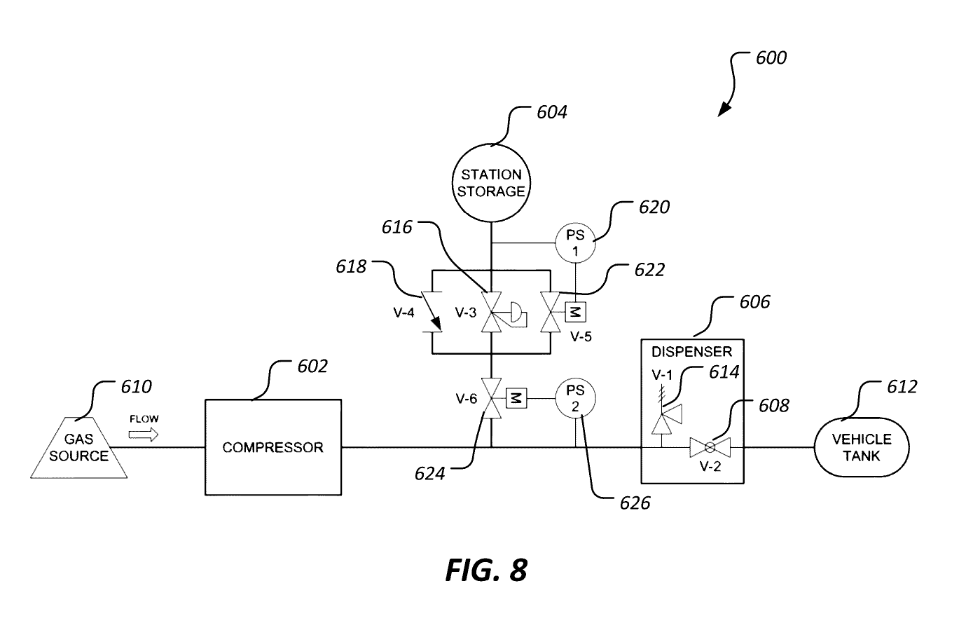

Referring now to FIG. 8, a CNG refueling station system 600 according to an embodiment of this disclosure is provided. The CNG refueling station system 600 comprises a compressor 602, a station storage container 604, a dispenser 606, a dispenser valve 608, a gas source 610, a vehicle tank 612, a relief valve 614, a pressure regulator 616 disposed between the station storage container 604 and the dispenser 606, a check valve 618 disposed in parallel with the pressure regulator 616, and a pressure switch 620 and actuated valve 622 disposed in parallel with the pressure regulator 616. The system 600 is substantially similar to the system 500 but further comprises an actuated valve 624 disposed in series with the pressure regulator 616. The actuated valve 624 can be useful in cases where the pressure regulator 616 is not a substantially complete shut off such that gas can leak past it even when closed. The actuated valve 622 can completely shut off gas flow and prevent the relief valve 614 from opening as a result of gas gradually escaping the pressure regulator 614. The actuated valve 624 can be actuated by a pressure switch 626 located downstream relative to the pressure regulator 616. When the pressure rises above a safe set point, the pressure switch 626 can cause the actuated valve 624 to close, shutting off the supply of gas to the dispenser 606. When gas begins to flow to the vehicle tank 612, the pressure in the line monitored by the pressure switch 626 would fall, causing the actuated valve 624 to open and allow gas to flow out of the station storage container.

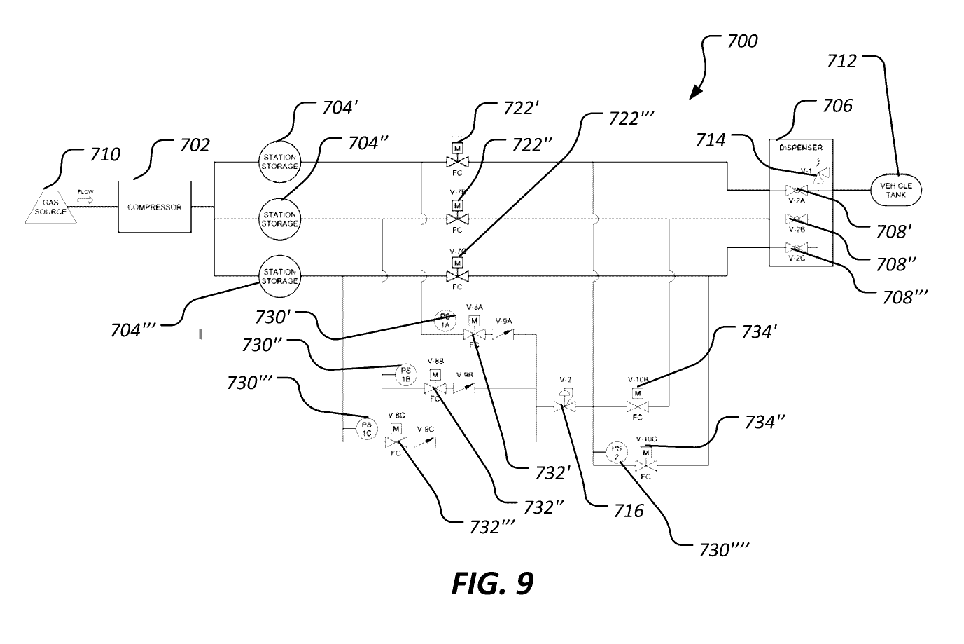

Referring to FIG. 9, a CNG refueling station system 700 according to an embodiment of this disclosure is provided. The system 700 a compressor 702, multiple station storage containers 704′, 704″, 704″′, a dispenser 706, multiple dispenser valves 708′, 708″, 708″′, a gas source 710, a vehicle storage tank 712, a relief valve 714, a single pressure regulator 716, and actuated valves 722′, 722″, 722′″ disposed in the current flow lines between the station storage containers 704′, 704″, 704′″ and the dispenser 706. Pressure switches 730′, 730″, 730″′, 730″″ and/or pressure transducers can be used to monitor each station storage container pressure as well as a downstream pressure (PS1A, PS1B, PS1C, PS2). The pressure switches 730′, 730″, 730″′, 730″″ are associated with actuated valves 732′, 732″, 732″′, 732″″. This allows the gas in the station storage containers 704′, 704″, 704″′ to rise above the set point of the dispenser relief valve 714. The block valves 722′, 722″, 722″′ in the flow lines (V-7A, V-7B, V-7C) will be closed preventing the high pressure gas from reaching the dispenser 706. The gas will flow from one storage bank through valve 732′″ (V-8C) to the pressure regulator 716 (V-2), then flow to each flow line downstream of the block valves 722′, 722″, 722″′ (V-7A, V-7B, V-7C) to the dispenser. Once an individual station storage container pressure is reduced below the dispenser pressure, the block valve 722′, 722″, 722″′ (such as V-7C) for the individual bank will be open and the next bank valve V-8B will be opened. This will continue until all of the station storage containers 704′, 704″, 704′″ are below the set pressure of the relief valve 714 and then all of the block valves 722′, 722″, 722″′ will be opened (V-7A, V-7B, V-7C). Additional valves can be added to prevent the high pressure station storage containers from feeding the lower pressure inputs on the dispenser. This allows the pressure in the lower pressure station storage containers to be depleted further, allowing more of the gas to be dispensed to the vehicle storage tank 712.

One example of operation of the system 700 is described further below. In some cases, a safe pressure below setting of dispenser relief valve 714 (V-1) can be set to be equal to a dispenser safe pressure (DSP). In a first step, when the pressure measured by pressure sensor 730″″ is greater than the DSP, all valves 722′, 722″, 722″′, 732′, 732″, 732″′ are closed. Next, when any of the pressures measured by pressure sensors 730′, 730″, 730′″ are measured as being greater than DSP, the corresponding ones of valves 732′, 732″, 732″′ are closed. Next, when the pressure measured by pressure sensor 730″′ is greater than DSP, valves 722′, 722″, 722″′, 732′, 732″ are closed and valves 732″′, 734′, 734″ are opened. Next, when the pressure measured by pressure sensor 730′″ is less than DSP and the pressure measured by pressure sensor 730″ is greater than DSP, valves 722′, 722″, 732′″, 734″ are closed and valves 722″′, 732″, 732″′, 734′ are open. Next, when the pressure measured by pressure sensor 730′ is greater than DSP and the pressure measured by pressure sensor 730″ is less than DSP and the pressure measured by pressure sensor 730′″ is less than DSP, valves 722′, 734′, 734″ are closed and valves 722″, 722′″, 732′, 732″, 732″′ are opened. Next if each of the pressures measured by pressure sensors 730′, 730″, 730″′ is less than DSP then valves 722′, 722″, 722′″, 732′, 732″, 732″′ are opened and valves 734′, 734″ are closed.

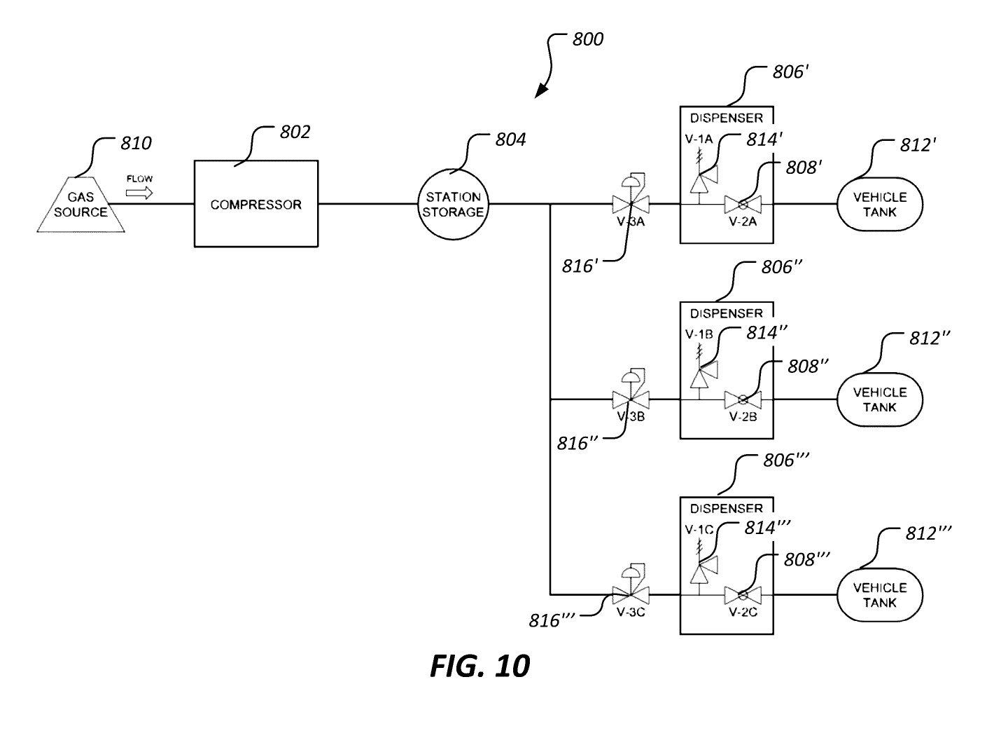

Referring now to FIG. 10, a CNG refueling station system 800 according to an embodiment of this disclosure is provided. The CNG refueling station system 800 comprises a compressor 802, a station storage container 804, dispensers 806′, 806″, 806″′ having dispenser valves 808′, 808″, 808″′, respectively, a gas source 810, vehicle tanks 812′, 812″, 812′″, relief valves 814′, 814″, 814″′, and pressure regulators 816′, 816″, 816″′ disposed between the station storage containers 804 and the dispensers 806′, 806″, 806″′. The system 800 is substantially similar to the system 300 but comprises a plurality of dispensers 806′, 806″, 806″′ and regulators 816′, 816″, 816′″ In this embodiment, the plurality of regulators 816′, 816″, 816″′ (V-3A, V-3B, V-3C) can be associated with dispensers 806′, 806″, 806′″ to prevent over pressuring the dispensers 806′, 806″, 806″′.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=R₁+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

1. A compressed natural gas (CNG) refueling station system, comprising:
a station storage container configured to receive gas at a first pressure;
a dispenser configured to deliver CNG to a vehicle tank up to a second pressure below the first pressure; and
a pressure regulator disposed between the station storage container and the dispenser.

2. The CNG refueling station system of claim 1, wherein the pressure regulator is configured to restrict an output pressure to a pressure lower than a maximum allowable pressure of a vehicle tank connected to the dispenser.

3. The CNG refueling station system of claim 1, wherein the station storage container is in fluid communication with each of a compressor and the dispenser via a single connection.

4. The CNG refueling station system of claim 3, wherein the pressure regulator is disposed between the station storage container and each of the compressor and the dispenser.

5. The CNG refueling station system of claim 4, further comprising:
a check valve connected both upstream and downstream relative to the pressure regulator.

6. The CNG refueling station system of claim 5, further comprising:
a first actuated valve connected both upstream and downstream relative to the pressure regulator.

7. The CNG refueling station system of claim 6, further comprising:
a first pressure switch connected between the station storage container and the pressure regulator.

8. The CNG refueling station system of claim 7, wherein the first actuated valve is actuated as a function of the operation of the first pressure switch.

9. The CNG refueling station system of claim 8, further comprising:
a second actuated valve disposed between the pressure regulator and each of the compressor and the dispenser.

10. The CNG refueling station system of claim 9, further comprising:
a second pressure switch connected between the second actuated valve and the dispenser.

11. The CNG refueling station system of claim 10, wherein the second actuated valve is actuated as a function of the operation of the second pressure switch.

12. A compressed natural gas (CNG) refueling station system, comprising:
a compressor;
a plurality of station storage containers connected downstream relative to the compressor;
a dispenser comprising a plurality of dispenser valves, each dispenser valve selectively in unrestricted fluid communication with respective station storage containers; and
each dispenser valve selectively in restricted fluid communication with respective station storage containers via a single pressure regulator.

13. A compressed natural gas (CNG) refueling station system, comprising:
a compressor;
a station storage container connected downstream relative to the compressor;
a plurality of dispensers connected downstream relative to the station storage container; and
a plurality of pressure regulators, each dispenser being connected to the station storage container via separate ones of the plurality of pressure regulators.
